(19) United States
(12) Patent Application Publication
(10) Pub. No.: US 2024/0056833 A1
(43) Pub. Date: Feb. 15, 2024

(54) PREDICTIVE BEAM MANAGEMENT WITH PER-BEAM ERROR STATISTICS

(71) Applicant: QUALCOMM Incorporated, San Diego, CA (US)

(72) Inventors: Tianyang BAI, Somerville, NJ (US); Hua WANG, Basking Ridge, NJ (US); Junyi LI, Fairless Hills, PA (US); Tao LUO, San Diego, CA (US)

(21) Appl. No.: 17/819,534

(22) Filed: Aug. 12, 2022

(51) Int. Cl. H04W 16/28; H04B 7/06

(52) U.S. Cl. CPC H04W 16/28; H04B 7/0632

(57) ABSTRACT

Schemes and mechanisms for beam prediction using per-beam error statistics are provided. A UE may receive, from a network, a beam prediction configuration. The beam prediction configuration may be for a machine learning model or algorithm. The UE may receive error statistics for each of a plurality of beam directions. Responsive to the UE identifying a first beam direction of the plurality of beam directions using the beam prediction configuration and based on the error statistics, the UE transmits an uplink (UL) communication to the network in the first beam direction. Responsive to the UE identifying a second beam direction of the plurality of beam directions using the beam prediction configuration and based on the error statistics, the UE transmits the UL communication to the network in a third beam direction different from the second beam direction.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

The radio frequency channel through which the BS and the UE communicate may have several channel properties that are considered for proper channel performance. The BS and UE may perform channel sounding to better understand these channel properties by measuring and/or estimating various parameters of the channel, such as delay, path loss, absorption, multipath, reflection, fading, doppler effect, among others. These channel measurements can also be used for channel estimation and channel equalization.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

According to an aspect of the present disclosure, a method of wireless communication performed by a user equipment (UE) comprises: receiving, from a network, a beam prediction configuration; receiving, from the network, error statistics for each of a plurality of beam directions; responsive to the UE identifying a first beam direction of the plurality of beam directions using the beam prediction configuration, the first beam direction associated with a first error statistic of the error statistics, transmitting an uplink (UL) communication to the network in the first beam direction; and responsive to the UE identifying a second beam direction of the plurality of beam directions using the beam prediction configuration, the second beam direction associated with a second error statistic of the error statistics different from the first error statistic, transmitting the UL communication to the network in a third beam direction different from the second beam direction.

According to another aspect of the present disclosure, a method of wireless communication performed by a network unit comprises: transmitting, to a user equipment (UE), a beam prediction configuration; transmitting, to the UE, error statistics for each of a plurality of beam directions; receiving, from the UE, a feedback signal indicating an error statistic for a predicted beam direction is below a threshold; and transmitting, to the UE based on the feedback signal, one or more reference signals in each of the plurality of beam directions.

According to another aspect of the present disclosure, a user equipment (UE) comprises: a memory device; a transceiver; and a processor in communication with the memory device and the transceiver. The UE is configured to: receive, from a network, a beam prediction configuration; receive, from the network, error statistics for each of a plurality of beam directions; responsive to the UE identifying a first beam direction of the plurality of beam directions using the beam prediction configuration, the first beam direction associated with a first error statistic of the error statistics, transmit an uplink (UL) communication to the network in the first beam direction; and responsive to the UE identifying a second beam direction of the plurality of beam directions using the beam prediction configuration, the second beam direction associated with a second error statistic of the error statistics different from the first error statistic, transmit the UL communication to the network in a third beam direction different from the second beam direction.

According to another aspect of the present disclosure, a network unit comprises: a memory device; a transceiver; and a processor in communication with the memory device and the transceiver. The network unit is configured to: transmit, to a user equipment (UE), a beam prediction configuration; transmit, to the UE, error statistics for each of a plurality of beam directions; receive, from the UE, a feedback signal indicating an error statistic for a predicted beam direction is below a threshold; and transmit, to the UE based on the feedback signal, one or more reference signals in each of the plurality of beam directions.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1A illustrates a wireless communication network according to some aspects of the present disclosure.

FIG. 1B illustrates an example disaggregated base station architecture according to some aspects of the present disclosure.

FIG. 2A illustrates wireless communication network according to some aspects of the present disclosure

FIG. 2B illustrates a wireless communication network according to some aspects of the present disclosure.

FIG. 3 illustrates CSI reporting periods according to some aspects of the present disclosure.

FIG. 4 illustrates beams associated with a wireless communications network according to some aspects of the present disclosure.

FIG. 5 is a signaling diagram of a wireless communication method according to some aspects of the present disclosure.

FIG. 6 is a block diagram of an exemplary user equipment (UE) according to some aspects of the present disclosure.

FIG. 7 is a block diagram of an exemplary network unit according to some aspects of the present disclosure.

FIG. 8 is a flow diagram of a communication method according to some aspects of the present disclosure.

FIG. 9 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

A wireless channel between the network (e.g., a BS) and a UE may vary over time. The BS may configure a set of beams for the UE, which at any point of time may use one or two serving beams to receive DL transmissions from or transmit UL transmissions to the BS. The BS and the UE may keep track of the serving beam(s) as well as candidate beams. For example, the UE may perform one or more measurements of one or more reference signals configured for the UE and may include the one or more measurements in a channel state information (CSI) report. If a serving beam fails, the BS may reconfigure the UE to use of the candidate beams. Candidate beams may be regularly updated because the channel quality between the BS and the UE may change over time. It may be desirable for the UE update the serving beam(s) according to the channel state. The UE may report the link quality of the serving beam(s) and the candidate beams in a CSI report to the BS, and the BS may process the CSI report and determine whether the UE's serving beam(s) or candidate beam(s) should be reconfigured. If the quality of a beam falls below a threshold, the BS may reconfigure a beam the UE's serving beam(s) or candidate beam(s). The BS may configure the threshold. Based on the determination, the BS may transmit a command to reconfigure the UE's serving beam(s) and/or candidate beam(s) in response to the CSI report.

The BS may configure the UE to periodically report the CSI report to the BS. The CSI report may include, for example, channel quality information (CQI) and/or reference signal received power (RSRP). CQI is an indicator carrying information on the quality of a communication channel. The BS may use the CQI to assist in downlink (DL) scheduling. The BS may use the RSRP to manage beams in multi-beam operations. The UE may perform different combinations of measurements for inclusion in the CSI report. Accordingly, the UE may transmit a CSI report including the CQI but not the RSRP, a CSI report including the RSRP but not the CQI, and/or a CSI report including both the CQI and the RSRP.

In 5G NR, machine learning (ML) algorithms may be implemented to assist cellular network performance. These ML algorithms may include neural networks that are implemented at different types of nodes within a wireless communication network. For example, the neural networks may be implemented at a single node (e.g., UE/BS/central cloud server) or may be distributed over multiple nodes. The ML algorithms may be implemented to assist with different functions and/or modules among the nodes of the wireless communication network. In various aspects, the neural network may be implemented as a convolutional neural network (CNN), a recurrent neural network (RNN), a deep convolutional network (DCN), among others.

At each node implemented with one or more ML algorithms, the ML algorithms may interact with different layers within the node. The ML algorithms may interact with one of the physical layer (PHY), the media access control (MAC) layer or upper layers (e.g., application layer) in some instances, or with multiple layers in other instances. For example, a node may include a ML module adapted for low-density parity check (LDPC) decoding at the PHY layer. In another example, a node may include a ML Module for CSI prediction and/or beam prediction or selection at the PHY layer and the MAC layer. In another example, a node may include a ML Module for multi-user (MU) scheduling taking account for package latency and/or priority at the PHY layer, the MAC layer and the upper layers. These ML algorithms may involve various ML-related data transfers between different layers of different nodes (e.g., UE, BS, central cloud server). The ML algorithms may be trained with training datasets that are produced through periodic and/or aperiodic data collection at one or more nodes. In various aspects, measurement data collection serves as input to the ML modules. The operation of these ML algorithms at the different nodes may be used for ML model parameter transfer and/or update. The ML model framework within the wireless communication network has the capability to send feedback signals and/or reports between the different nodes. In various aspects, the UE may feed back channel measurements that are indicative of the ML model prediction accuracy. For example, the measurement data collection by the UE that is then sent to the BS and/or central cloud server with a report may indicate that the ML model is producing prediction errors, thus indicative that the ML model requires updating. The ML modules may provide intermediate data transfer between the different nodes (e.g. to facilitate training with stochastic gradient decent and backpropagation for a distributed ML algorithm).

In various aspects, the UE may include different ML algorithms on board to predict channel properties for a future use of that channel. For example, the machine learning-based network may be implemented by a channel property prediction network to predict one or more properties of a channel. In some aspects, the ML algorithms are tasked to predict what transmission beam direction to use for the B S and/or reception beam to use for the UE. For example, the machine learning-based network may be implemented by a beam selection prediction network to predict the BS transmission beam and/or the UE reception beam.

In some aspects, some beam directions may be more prone to errors when they are predicted by a ML algorithm to be used for communications with a BS. For example, the network may record error statistics during a ML training procedure in which the ML-predicted beam directions are compared with the observed “best” beam directions identified based on channel measurements. Some of the beam directions may have qualities or characteristics that make accurate ML-based prediction difficult. For example, beam directions that are non-boresight beam directions, or are further away from the boresight beam direction, may have lower directivity gains and therefore may result in greater variability as observed by UEs. Further, some beam directions may experience different environment scenarios, such as non-line-of-sight (NLOS), which may have less predictable performance. The network may collect error statistics for each beam over time, where the error statistics reflect the likelihood that each beam direction will be correctly predicted by a ML algorithm as a “best” beam.

The present disclosure provides techniques for validating ML-based beam prediction based on per-beam error statistics. For example, in one aspect, a UE may be configured to receive, from a network, a beam prediction configuration for performing a beam prediction procedure, and error statistics for a plurality of beam directions. The beam prediction procedure may include or involve a ML algorithm for predicting a best beam for communication with the network. The UE may use previously recorded channel measurements as an input, and the beam prediction procedure may output or indicate at least one beam direction for communication with the network. The UE may compare the predicted beam direction with a corresponding beam-specific error statistics provided by the network to determine whether to proceed with the predicted beam direction, or to select a different beam direction other than the predicted beam direction.

Aspects of the present disclosure can provide several benefits. For example, using ML-based procedures to predict beam directions for communication with the network may reduce network overhead for receiving reports, transmitting reference signals (RSs), and/or updating beam configurations. For example, the network may transmit beam-related RSs less frequently and may receive reports from the UEs less frequently. Further, erroneous beam predictions may be mitigated or prevented by the UEs whereby less predictable beam directions may not be accepted or used by UEs if selected by a beam prediction algorithm. Accordingly, network overhead can be reduced while reducing any prediction-related errors in communications between the UE and the network.

An aggregated base station may be configured to utilize a radio protocol stack that is physically or logically integrated within a single random access network (RAN) node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

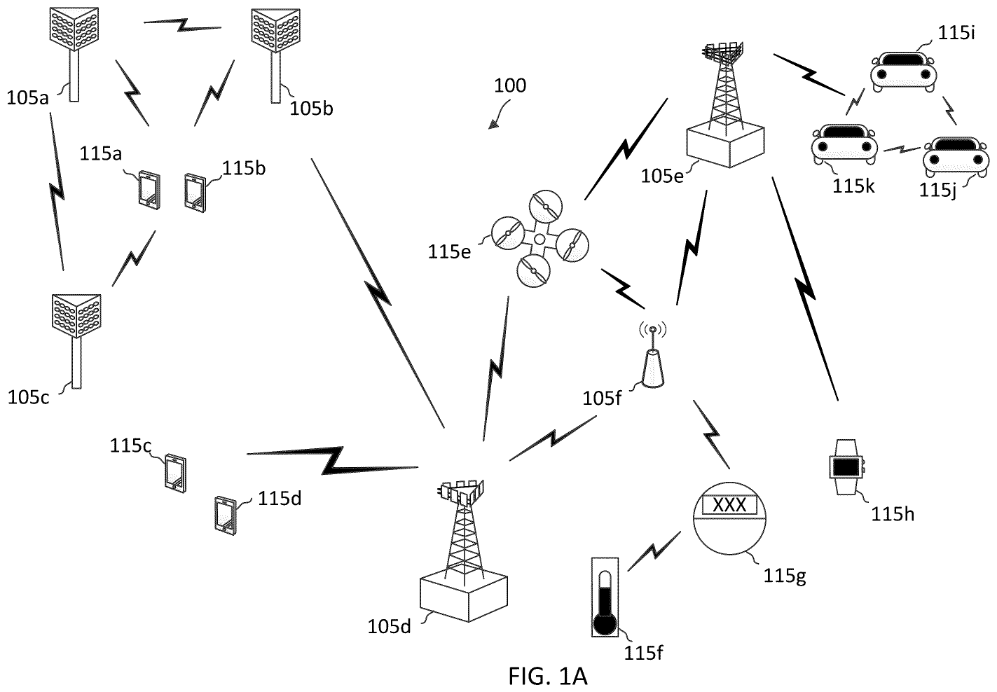

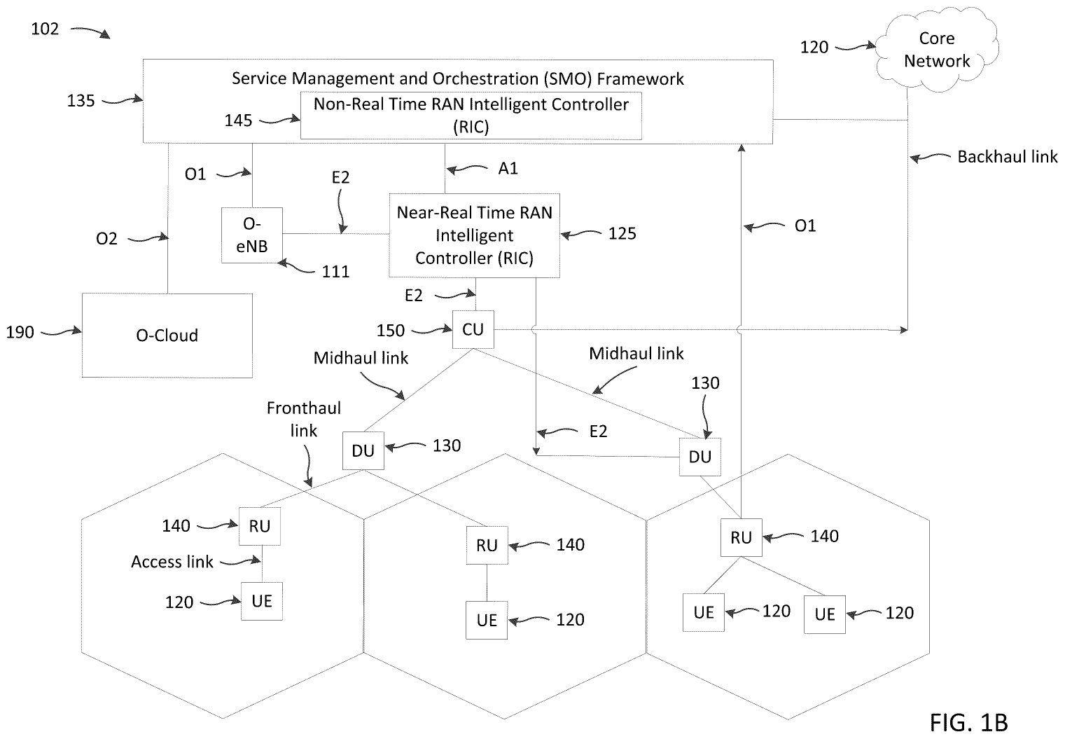

FIG. 1A illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1A, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. ABS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1A, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (MC), a Non-Real Time (Non-RT) RIC, integrated access and backhaul (IAB) node, a relay node, a sidelink node, etc.

In some aspects, a method of wireless communication may be performed by the UE 115. The method may include receiving a first reference signal associated with the BS 105a, measuring at least one of a power delay profile (PDP) associated with the first reference signal or an angle of arrival (AOA) associated with the first reference signal, and determining a beam failure associated with a second reference signal associated with the BS 105b based on the at least one of the PDP or the AOA, wherein the BS 105a is different from the BS 105b.

FIG. 1B shows a diagram illustrating an example disaggregated base station 102 architecture. The disaggregated base station 102 architecture may include one or more central units (CUs) 150 that can communicate directly with a core network 104 via a backhaul link, or indirectly with the core network 104 through one or more disaggregated base station units (such as a Near-Real Time (Near-RT) RAN Intelligent Controller (RIC) 125 via an E2 link, or a Non-Real Time (Non-RT) RIC 145 associated with a Service Management and Orchestration (SMO) Framework 135, or both). A CU 150 may communicate with one or more distributed units (DUs) 130 via respective midhaul links, such as an F1 interface. The DUs 130 may communicate with one or more radio units (RUs) 140 via respective fronthaul links. The RUs 140 may communicate with respective UEs 120 via one or more radio frequency (RF) access links. In some implementations, the UE 120 may be simultaneously served by multiple RUs 140.

Each of the units, i.e., the CUs 150, the DUs 130, the RUs 140, as well as the Near-RT RICs 125, the Non-RT RICs 145 and the SMO Framework 135, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 150 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 150. The CU 150 may be configured to handle user plane functionality (i.e., Central Unit-User Plane (CU-UP)), control plane functionality (i.e., Central Unit-Control Plane (CU-CP)), or a combination thereof. In some implementations, the CU 150 can be logically split into one or more CU-UP units and one or more CU-CP units. The CU-UP unit can communicate bidirectionally with the CU-CP unit via an interface, such as the E1 interface when implemented in an O-RAN configuration. The CU 150 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 130 may further host one or more low PHY layers. Each layer (or module) can be implemented with an interface configured to communicate signals with other layers (and modules) hosted by the DU 130, or with the control functions hosted by the CU 150.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs. In some implementations, real-time and non-real-time aspects of control and user plane communication with the RU(s) 140 can be controlled by the corresponding DU 130. In some scenarios, this configuration can enable the DU(s) 130 and the CU 150 to be implemented in a cloud-based RAN architecture, such as a vRAN architecture.

The SMO Framework 135 may be configured to support RAN deployment and provisioning of non-virtualized and virtualized network elements. For non-virtualized network elements, the SMO Framework 135 may be configured to support the deployment of dedicated physical resources for RAN coverage requirements which may be managed via an operations and maintenance interface (such as an O1 interface). For virtualized network elements, the SMO Framework 135 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 150, DUs 130, RUs 140 and Near-RT RICs 125. In some implementations, the SMO Framework 135 can communicate with a hardware aspect of a 4G RAN, such as an open eNB (O-eNB) 111, via an O1 interface. Additionally, in some implementations, the SMO Framework 135 can communicate directly with one or more RUs 140 via an O1 interface. The SMO Framework 135 also may include a Non-RT RIC 145 configured to support functionality of the SMO Framework 135.

The Non-RT RIC 145 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 145 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 150, one or more DUs 130, or both, as well as an O-eNB, with the Near-RT RIC 125.

In some implementations, to generate AI/ML models to be deployed in the Near-RT RIC 125, the Non-RT RIC 145 may receive parameters or external enrichment information from external servers. Such information may be utilized by the Near-RT RIC 125 and may be received at the SMO Framework 135 or the Non-RT MC 145 from non-network data sources or from network functions. In some examples, the Non-RT MC 145 or the Near-RT RIC 125 may be configured to tune RAN behavior or performance. For example, the Non-RT RIC 145 may monitor long-term trends and patterns for performance and employ AI/ML models to perform corrective actions through the SMO Framework 135 (such as reconfiguration via O1) or via creation of RAN management policies (such as A1 policies).

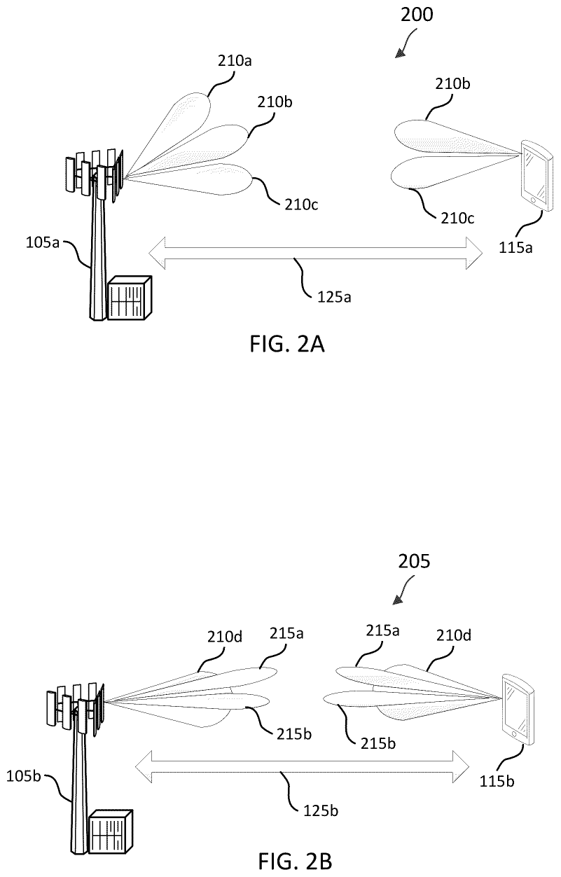

FIG. 2A illustrates an example of a wireless communications network 200 that supports beam change reporting via prediction based beam management according to some aspects of the present disclosure. The wireless communications network 200 may implement aspects of the wireless communications network 100, 200, or 205, as described with reference to FIGS. 1, 2A, and 2B. The wireless communications network 200 may include a UE 115a which may be an example of a UE 115 as described herein. The wireless communications network 200 may also include a base station 105a which may be an example of a base station 105 as described herein. The base station 105a may be referred to as a network unit. In some aspects, the base station 105a may communicate with the UE 115a using directional communications techniques. For example, the base station 105a may communicate with the UE 115a via one or more beams 210. The base station 105a may communicate with the UE 115a via a communication link 225a, which may be an example of an NR or LTE link between the UE 115a and the base station 105a. In some cases, the communication link 225a may include an example of an access link (e.g., Uu link). The communication link 225a may include a bi-directional link that enables both uplink and downlink communication. For example, the UE 115a may transmit uplink signals, such as uplink control signals or uplink data signals, to the base station 105a using the communication link 225a and the base station 105a may transmit downlink signals, such as downlink control signals or downlink data signals, to the UE 115a using the communication link 225a.

As part of transmitting downlink data to the UE 115a via the communication link 225a, the base station 105a may sweep a set of transmission beams (e.g., a first transmission beam 210a, a second transmission beam 210b, and a third transmission beam 210c, etc.) across the communication link 225a according to a beam sweeping pattern. In some aspects, the beam sweeping pattern may include transmitting a set of SSBs across the set of transmission beams 210. The base station 105a may transmit an indication of the beam sweep pattern to the UE 115a. The UE 115a may perform measurements upon the SSBs received across the beams 210 and transmit a CSI report to the base station 105a indicating measured and/or predicted parameters associated with beams 210. For example, the CSI report may indicate a strongest beam at a previous and/or a future time period. The UE 115a and the base station 105a may establish communications over the communication link 225a based on the CSI report. For example, the base station 105a and the UE 115a may perform an SSB beam sweep and report procedure during an initial access procedure (e.g., as part of a random access channel (RACH) procedure). Beams used for SSB beam sweeping may be wide beams (e.g., layer 1 (L1) beams).

FIG. 2B illustrates an example of a wireless communications network 205 that supports beam change reporting via prediction based beam management according to some aspects of the present disclosure. In some aspects, the wireless communications network 205 may be implemented by or may implement aspects of the wireless communications network 100, 200, or 205, as described with reference to FIGS. 1, 2A, and 2B. The wireless communications network 205 may include a UE 115b which may be an example of a UE 115 as described herein. The wireless communications network 205 may also include a base station 105b which may be an example of a base station 105 as described herein. The base station 105b may be referred to as a network unit.

In some aspects, the base station 105b may communicate with the UE 115b using directional communications techniques. For example, the base station 105b may communicate with the UE 115b via one or more beams 210. The base station 105b may communicate with the UE 115b via a communication link 225b, which may be an example of an NR or LTE link between the UE 115b and the base station 105b. In some cases, the communication link 225b may include an example of an access link (e.g., Uu link). The communication link 225b may include a bi-directional link that enables both uplink and downlink communication. For example, the UE 115b may transmit uplink signals, such as uplink control signals or uplink data signals, to the base station 105b using the communication link 225b and the base station 105b may transmit downlink signals, such as downlink control signals or downlink data signals, to the UE 115b using the communication link 225b.

As part of transmitting downlink data to the UE 115b via the respective communication link 225b, the base station 105b may sweep a set of transmission beams 210d across the communication link 225b according to a beam sweeping pattern. In some aspects, the beam sweeping pattern may include transmitting a set of CSI-RSs across the set of transmission beams 210d (e.g., the base station 105b may transmit CSI-RS 215a and CSI-RS 215b). The base station 105b may transmit an indication of the beam sweep pattern to the UE 115b. The UE 115b may perform measurements upon the CSI-RSs received across the beams 210d and transmit a CSI report to the base station 105b indicating channel state information. In some aspects, the base station 105b may indicate a configuration for a CSI report setting associated with measured and/or predicted parameters associated with beams 210 and 215. For example, the CSI report may indicate a strongest predicted beam. The UE 115b and the base station 105b may maintain or update communications over the communication link 225b based on the CSI report. For example, the base station 105b and the UE 115b may periodically perform a CSI-RS beam sweep and report procedure while in an RRC connected mode. In some aspects, the base station 105b and the UE 115b may perform a CSI-RS beam sweep and CSI report procedure as part of a beam failure recovery procedure (e.g., to facilitate recovery) or a radio link failure procedure (e.g., to re-establish communications).

The CSI-RS beam sweep may be a P1, P2, and/or P3 procedure. P1 may be a beam selection procedure where the BS 105b sweeps the beam and the UE 115b selects the strongest beam and reports the strongest beam to the BS 105b. P2 may be a beam refinement procedure for the BS 105b, where the BS 105b may refine a beam (e.g., via sweeping a narrower beam over a narrower range), and the UE 115b may detect and report the strongest beam (e.g., from the set of narrower beams) to the BS 105b. P3 may be a beam refinement procedure for the UE 115b, where the BS 105b may fix a beam (e.g., transmit the same beam repeatedly), and the UE 115b may refine its receiver to optimize receipt of the fixed beam. The BS 105b and the UE 115b may perform a similar processes, but in reverse, for uplink beam management (e.g., U1, U2, and/or U3 procedures).

The UE 115b may report a SSB resource block indicator (SSBRI), a CSI-RS resource indicator (CRI), an L1 reference signal received power (RSRP), and/or an L1 signal-to-noise and interference ratio (SINR) via the CSI report. The UE 115b may receive from the BS 105b a report quantity message indicating which parameters (e.g., SSBRI, CRI, SSB RSRP/SINR, CSI-RS RSRP/SINR, CQI, PMI, LI, RI, etc.) should be measured and reported via the CSI report. For example, the CSI report setting configuration for the UE 115b may include the fields ReportQuantity=ssb-Index-RSRP, ssb-Index-SINR, cri-RSRP, and/or cri-SINR for joint SSBRI/CRI and L1-RSRP/L1-SINR beam reporting. The UE 115b may report a number of different SSBRIs or CRIs for each CSI report configuration, where the number may be equal to the number of reported reference signals. The number of reported reference signals may be configured via RRC messaging.

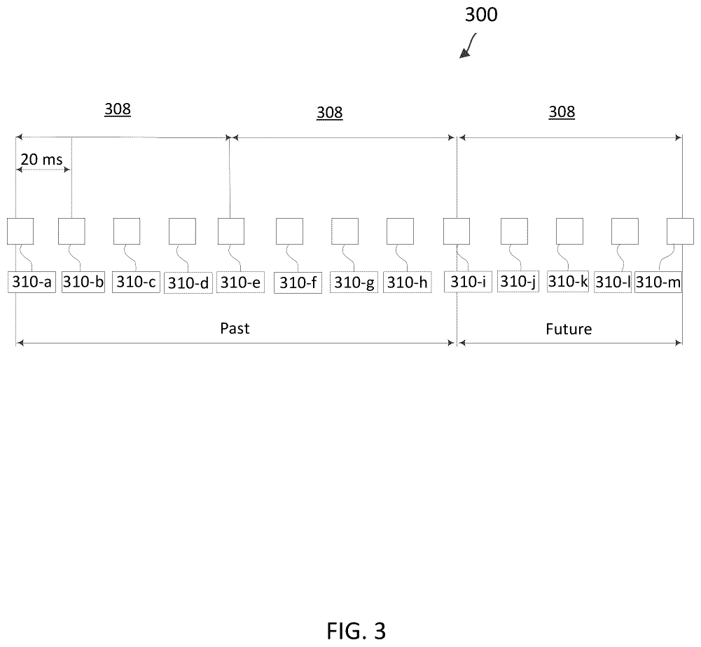

FIG. 3 illustrates an example of a timing diagram 300 that supports beam change reporting via prediction based beam management in accordance with some aspects of the present disclosure. In some aspects, the timing diagram 300 may be implemented by or may implement aspects of the wireless communications network 100, 200, or 205, as described with reference to FIGS. 1, 2A, and 2B.

In some instances, a UE (e.g., the UE 115 or 600) may predict whether the strongest beam index may change (or change more frequently and/or dynamically) at a future time (or in a future time window). The UE may predict the changes in the strongest beam index using measurements obtained based on a beam management periodicity 308. In some instances, the UE may utilize a beam management periodicity 308 that is longer than a default beam management periodicity (e.g., 20 or 40 ms). In some instances, the beam management periodicity 308 may be greater than 100 ms, including without limitation 200 ms, 300 ms, 400 ms, 500 ms, and/or any other suitable periodicity 308.

In some instances, the UE may utilize less than all available CSI-RS or SSB resources to predict a strongest beam index and/or a change in the strongest beam index. For example, the UE may utilize a subset of measured beams (e.g., 2, 3, 4, 5, 6, 7, 8, etc. measured beams) to predict a strongest beam from a larger set of potential beams (e.g., 12, 16, 18, 20, 24, 32, 64, etc. measured beams). For example, the UE may predict future strongest beam indices 310-j, 310-k, 310-l, and/or 310-m based on the past measured beam indices 310-a, 310-b, 310-c, 310-d, 310-e, 310-f, 310-g, and/or 310-h. In some aspects, the UE may send requests to the BS for decreased beam management periodicity 308 or an increased number of CSI-RS/SSB resources if the strongest beam index is predicted to change or predicted to change more dynamically.

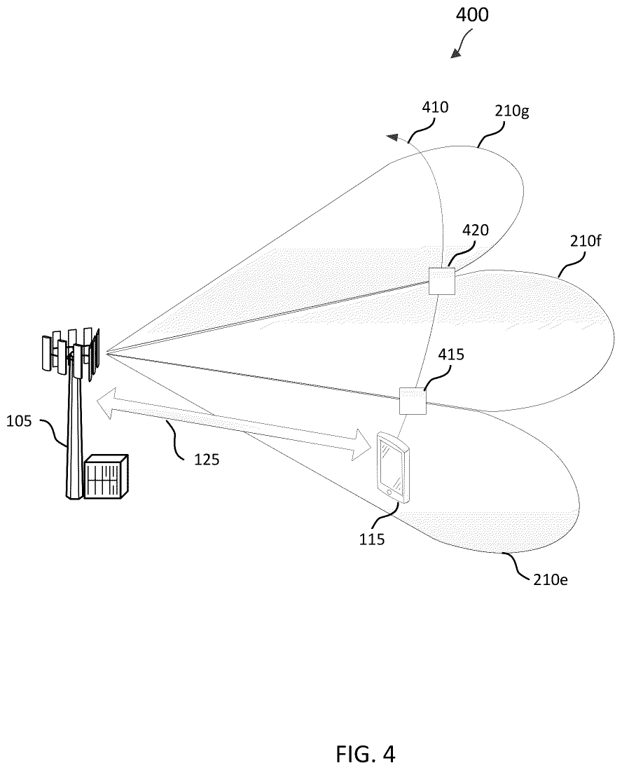

FIG. 4 illustrates an example of a wireless communications system 400 that supports beam change reporting via prediction based beam management in accordance with some aspects of the present disclosure. The wireless communications system 400 may be implemented by or may implement aspects of the wireless communications system 100, 200, or 205, as described with reference to FIGS. 1, 2A, and 2B. The wireless communications system 400 may include a UE 115 which may be an example of a UE 115 as described herein. The wireless communications system 400 may also include a base station 105 which may be an example of a base station 105 as described herein.

In some examples, the base station 105 may communicate with the UE 115 using directional communications techniques. For example, the BS 105 may communicate with the UE 115 via one or more beams 210. The BS 105 may communicate with the UE 115 via a communication link 425, which may be an example of an NR or LTE link between the UE 115 and the BS 105. In some aspects, the communication link 425 may include an example of an access link (e.g., Uu link). The communication link 425 may include a bi-directional link that enables both uplink and downlink communication. For example, the UE 115 may transmit uplink signals, such as uplink control signals or uplink data signals, to the BS 105 using the communication link 425 and the BS 105 may transmit downlink signals, such as downlink control signals or downlink data signals, to the UE 115 using the communication link 425.

As the UE 115 moves along a path 410, the strongest beam 210 may change. For example, at point 415, the strongest beam may change from beam 210e to beam 210f. At point 420, the strongest beam may change from beam 210f to beam 210g. When the UE 115 moves along the path 410 at a slow speed the beams 210 may largely be stationary (e.g., at a 20 ms beam management cycle, the strongest beam may be unchanged in a majority of the CSI reports).

In some aspects, the UE 115 may report an SSB resource block indicator (SSBRI), a CSI-RS resource indicator (CRI), a layer 1 reference signal received power (RSRP) associated with the CSI-RS resources, and/or a signal-to-noise and interference ratio (SINR) associated with the CSI-RS resources via the CSI report. The UE 115 may receive from the BS 105 a report quantity message indicating which parameters (e.g., SSBRI, CRI, SSB RSRP/SINR, CSI-RS RSRP/SINR, CQI, PMI, LI, RI, etc.) should be measured and reported via the CSI report. For example, the CSI report configuration for the UE 115 may include the fields ReportQuantity=ssb-Index-RSRP, ssb-Index-SINR, cri-RSRP, and/or cri-SINR for joint SSBRI/CRI and L1-RSRP/L1-SINR beam reporting. The UE 115 may report a number of different SSBRIs or CRIs for each CSI report configuration, where the number may be equal to the number of reported reference signals. The number of reported reference signals may be configured via RRC messaging.

In some aspects, the configuration for the CSI report setting may indicate that the CSI report may include parameters of predicted channel characteristics associated with the CSI-RS resources and/or the SSB resources. In some aspects, the UE 115 may be configured to transmit a CSI report periodically (e.g., every 20 ms, 40 ms, 80 ms, etc.). Frequent beam management and transmission of CSI reports (e.g., every 20 ms or 40 ms) may consume UE 115 overhead and/or UE 115 power. In stationary or low mobility UE scenarios, the strongest beam 210 index may not change frequently (e.g., may not change over hundreds of ms, seconds, minutes, or even longer periods of time), therefore the UE 115 may reduce overhead and/or power consumption by predicting a strongest beam 210 change at future time (e.g. the UE 115 at points 415 and 420) and transmitting a CSI report less frequently and/or on request from the BS 105. In some aspects, the UE 115 may use an artificial intelligence based beam prediction technique that may rely on parameters of predicted channel characteristics associated with the CSI-RS resources and/or the SSB resources. For example, the UE 115 may use a convolutional neural network (CNN), a recurrent neural network (RNN), a long short-term memory (LSTM), or the like for predicting parameters of channel characteristics including, without limitation, the strongest beam 210 index.

In some instances, the UE 115 may predict whether the strongest beam 210 index may change (or change more frequently and/or dynamically) at a future time (or in a future time window) as the UE moves along path 410. The UE 115 may predict the changes in the strongest beam 210 index using measurements obtained based on a beam management periodicity. In some instances, the UE 115 may utilize a beam management periodicity that is longer than a default beam management periodicity (e.g., 20 or 40 ms). In some instances, the beam management periodicity may be greater than 100 ms, including without limitation 200 ms, 300 ms, 400 ms, 500 ms, and/or any other suitable periodicity.

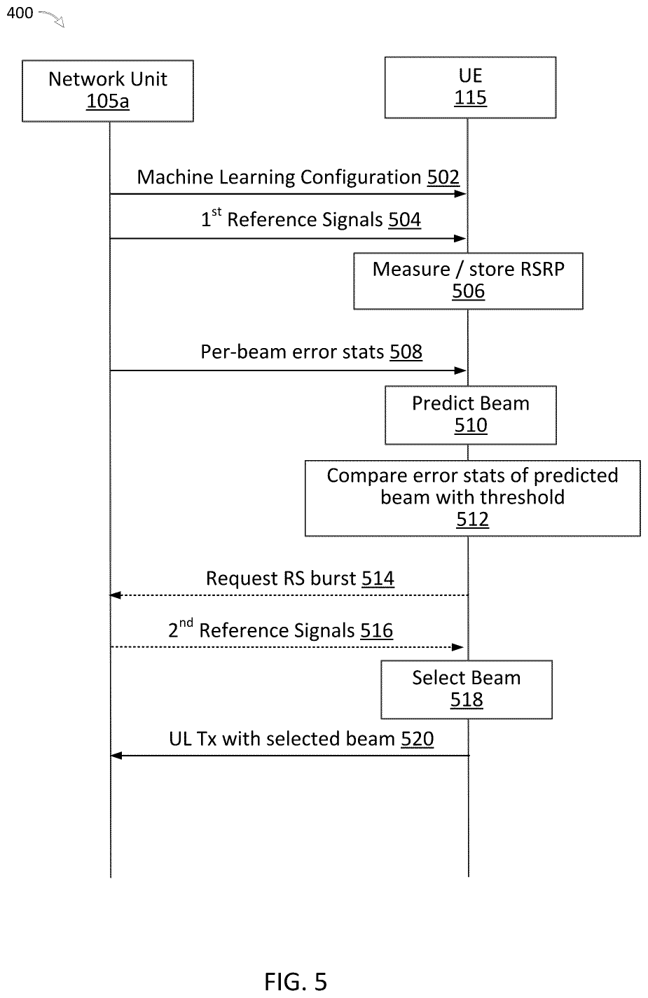

FIG. 5 is a flow diagram of a wireless communication method 500 according to some aspects of the present disclosure. Actions of the communication method 500 can be executed by a computing device (e.g., a processor, processing circuit, and/or other suitable component) of a communication device or other suitable means for performing the actions. For example, a wireless communication device, such as the UE 115, UE 120, or UE 600, may utilize one or more components, such as the processor 602, the memory 604, the beam prediction module 608, the transceiver 610, the modem 612, and the one or more antennas 616, to execute aspects of method 500.

At action 502, the UE 115 may receive a machine learning configuration from the network unit 105a. In this regard, the UE 115 may receive the machine learning configuration from the network unit 105a via RRC signaling, a PDCCH communication, a PD SCH communication, or other suitable communication. The machine learning configuration may include, without limitation, identification of ML model inputs, weights, vectors, coefficients, equations, algorithms, type of ML model, etc. The machine learning configuration may be used by the UE to perform a ML algorithm to predict beam characteristics of each of a plurality of beam directions. In some aspects, the ML algorithm may be used by the UE to predict a best beam direction, one or more acceptable beam directions, and/or to rank beam directions based on their predicted performance for a given time, location, use-case, and/or power saving mode of the UE. In some aspects, the machine learning configuration may be referred to as a beam prediction configuration. The UE 115 may perform a beam prediction procedure using the beam prediction configuration and one or more associated inputs and/or input parameters. The inputs may include signal or channel measurements, such as signal power, signal quality, signal-to-noise ratio (SNR), and/or any other suitable type of channel measurements. In some aspects, the inputs may include measurements suitable for reporting in a channel state information (CSI) report. Further, the input parameters may include a time associated with the measurements (e.g., a timestamp, time window, etc.), a power-saving mode status of the UE 115, a current and/or future use-case for the UE's communications, and/or any other suitable parameter.

At action 504, the UE 115 may receive one or more first reference signals from a network unit 105a (e.g., BS 105a). The BS 105a may be a first serving cell. The first reference signals may include channel state information reference signals (CSI-RS), one or more synchronization signal blocks (SSBs), and/or other reference signal. In some aspects, the first serving cell may be a serving cell operating in at least frequency range 1 (FR1). The FR1 may include frequencies in the range of about 5.1 GHz to about 7.125 GHz. In addition to or in lieu of FR1, the first serving cell may operate in one or more other frequency ranges. In another aspect, the first serving cell may be operating in FR2. FR2 frequency range may include frequencies in the range of about 24.25 GHz to about 52.6 GHz. However, it will be understood that these ranges are exemplary and that FR1 and/or FR2 may cover other ranges than those explicitly stated herein.

The network unit 105a may transmit the one or more first reference signals in a burst such that the one or more reference signals (RSs) is transmitted in each of a plurality of beam directions. In some aspects, the transmission of the one or more first RSs may be referred to as a beam sweep. In some aspects, each beam direction may be associated with a corresponding transmission configuration indicator (TCI) state identifier, a RS ID, a CSI-RS ID, a SSB ID, and/or an output port ID associated with the ML configuration. In some aspects, the network unit 105a may transmit the one or more first RS in each of the plurality of beam directions associated with the ML configuration described above with respect to action 502. In another aspect, the network unit 105a may transmit the one or more first RS in a subset of the plurality of beam directions associated with the ML configuration described above with respect to action 502. In some aspects, the first RSs may comprise channel state indicator reference signals (CSI-RS), synchronization signals, DMRSs, phase tracking RS (PTRS), and/or any other suitable type of reference signal.

At action 506, the method 500 includes the UE 115 measuring and/or storing signal power measurements based on the one or more first RSs transmitted and received in action 504. In some aspects, action 506 may comprise the UE 115 obtaining reference signal received power (RSRP) measurements, and storing the RSRP measurements on a memory device. In another aspects, action 506 may comprise the UE 115 obtaining reference signal received quality (RSRQ) measurements, received signal strength indicator (RSSI), SNR measurements, and/or any other suitable type of signal or channel measurement associated with the first RSs. In some aspects, the UE 115 may obtain and/or store the channel measurements (e.g., RSRP, RSRQ, RSSI, SNR, etc.) over a period of time such that the measurements represent measurements of different RS bursts at different times, use cases, physical conditions, and/or any other circumstances.

In some aspects, action 506 includes the UE 115 obtaining for the channel measurements for each of a plurality of beam directions. As explained above, each of the plurality of beam directions may be associated with at least one of a TCI state ID, a CSI-RS ID, a SSB ID, a RS ID, and/or an output port ID associated with the ML configuration. The plurality of beam directions may comprise the plurality of beam directions associated with the ML configuration. In another example, the plurality of beam directions for which the UE 115 obtains and/or stores channel measurements may be a subset of the plurality of beam directions associated with the ML configuration.

At action 508, the network unit 105a transmits, and the UE 115 receives, one or more beam-specific error statistics. In some aspects, the network unit 105a may transmit the error statistics via a RRC IE, a MAC-IE, MAC-CE, DCI, and/or any other suitable communication or message. In some aspects, the error statistics may be generated based on a ML training procedure performed by the network. For example, training losses and/or losses during validation of a dataset may be obtained to generate an error data-set indicating one or more error statistics for each of the plurality of beam directions. In some aspects, the statistics may include an error rate for each beam direction. In some aspects, the error statistics may include an average error rate for each beam direction. In other aspects, the statistics may indicate a relative ranking or likelihood of error for each beam direction. In another aspect, the statistics may indicate one or more beam directions associated with a highest rate of error. In another aspect, the error statistics may indicate, for each of the plurality of beam directions, a difference in signal power between the respective predicted beam direction and an observed best beam direction. In another aspect, the error statistics may indicate, for each of the plurality of beam directions, a different in signal strength, signal quality, SNR, and/or any other suitable beam direction between the respective predicted beam direction and the observed best beam direction.

In one aspect, the beam error statistics may be relative to the “predicted” best beam direction, or a “genie” best beam direction. In some aspects, the predicted best beam direction may be the beam that is predicted by the ML-based beam prediction configuration. The “genie” best beam direction may be described as an actual observed best beam direction that is determined based on contemporaneous RS measurements. For example, a first type of error statistics may be determined and provided by the network based on genie beam association. In a different example, a second type of error statistics may be determined and provided based on a predicted beam association.

At action 510, the method 500 includes the UE 115 performing a beam prediction procedure based on at least the ML configuration and the RS measurements performed at action 506. For example, the ML configuration may indicate one or more parameters for a neural network function (NNF). The NNF may be supported by a beam prediction model. The beam prediction model may be a neural network model. The neural network model may include, or be associated with, a model structure. The neural network model may be defined as a model structure and a parameter set. The neural network model may be hard coded in the UE 115. The model structure may be indicated with a model ID. The model ID may be associated with one parameter set. For example, a first model ID may be associated with a first model structure and a first parameter set, and a second model ID may be associated with a second model structure and a second parameter set. The first model structure may be different from the second model structure. The first parameter may be different from the second parameter set. In some aspects, each model ID may be unique in the corresponding network. In another aspect, each model ID may be associated with or correspond to a NNF. A parameter set may include, for example, weights for the neural network model and/or other ML configuration parameters. The parameter set may be specific to a location, on some aspects.

The NNF may be performed by the UE 115 and may receive, as inputs, the channel measurements obtained and/or stored at action 506, and/or one or more other parameters, such as a current time, UE use case and/or sub-use case, power saving mode status, and/or any other suitable input. The UE 115 may execute or perform the NNF, which may output a beam prediction. In some aspects, the beam prediction may include a best predicted beam direction of the plurality of beam directions. In another aspect, the beam prediction may include a ranking of two or more beam directions of the plurality of beam directions. In another aspect, the beam prediction may include one or more beam directions that exceed a predicted threshold of channel performance, such as predicted RSRP, RSRQ, SNR, and/or any other suitable performance threshold. In another aspect, the beam prediction may include a predicted performance for each beam direction of the plurality of beam directions. Accordingly, the UE 115 may identify, based on the beam prediction, a best predicted beam direction.

At action 512, the UE 115 compares the error statistics of the predicted beam direction with a configured error threshold. In this regard, in some aspects, the network unit 105a may transmit, and the UE 115 may receive, an indication of one or more error thresholds associated with one or more beam directions. For example, the error threshold may indicate a maximum acceptable average error rate for at least one beam direction of the plurality of beam directions. In some aspects, an error threshold may be provided for each beam direction of the plurality of beam directions. In another example, a single threshold may be provided for the plurality of beam directions. In another aspect, an error threshold may indicate a lowest acceptable ranking for beam prediction error. For example, the threshold may indicate that the n t h least erroneous beam directions are acceptable for prediction by the ML model, and that any beam directions that the n−1 beam directions that have higher relative likelihoods of erroneous beam prediction are unacceptable for prediction by the ML model. As explained above, the observed best beam direction may be referred to as a genie best beam direction. The observed best beam direction may be based on channel measurements (e.g., RSRP, RSRQ, RSSI, SNR, etc.) of one or more RS bursts for the plurality of beam directions.

In some aspects, comparing the error statistics for the predicted beam direction with the configured error threshold may result in the UE 115 determining or selecting the beam direction determined or predicted at action 510 to communicate with the network unit 105a. In another example, comparing the error statistics for the predicted beam direction with the configured error threshold may result in the UE 115 determining or selecting a different beam direction that is not the predicted beam direction to communicate with the network unit 105a. Accordingly, the error statistics and configured threshold may facilitate a conditional application of the beam prediction model to prevent the UE 115 from using a predicted beam that is more likely to be erroneously predicted by the beam prediction model.

In some aspects, the error thresholds may be based on the error statistics for each beam direction. For example, the error threshold may indicate a difference between a beam prediction probability determined using the beam prediction model at action 510 and an error probability of the beam direction as indicated in the error statistics. Accordingly, if the beam prediction probability determined based on the beam prediction model or neural network model is higher than the error probability by at least the indicated error threshold, the UE 115 may select the predicted beam direction for UL communications. Otherwise, the UE 115 may select a different beam direction, as explained further below.

In this regard, actions 514 and 516 illustrate an optional or alternative step performed when the UE 115 determines, based on the error statistics for the predicted beam from action 510, that the predicted beam direction is not to be used for communications with the network unit 105a. In action 514, the UE 115 transmits, to the network unit 105a based on the determination of action 512, a request for an RS burst. In some aspects, the UE 115 may request an aperiodic RS burst, or instance of a RS burst. In another aspect, the UE may request the network to activate a semi-persistent RS or RS burst at action 514. In another aspect, the UE 115 may not request the network to activate the semi-persistent RS. For example, the UE 115 may revert to the previously active or configured beam direction, and may wait for the next periodically or semi-periodically configured RS burst. In some aspects, transmitting the request for the RS burst to the network unit 105a may comprise transmitting a uplink control information (UCI), a MAC-CE, and/or any other suitable message.

At action 516, based on the request from the UE 115, the network unit 105a transmits, and the UE 115 receives, a second RS burst. The second RS burst may comprise instances of a second RS in each of the plurality of beam directions. The second RS burst may comprise a same type of RS as the first RS burst, or may comprise a different type of RS. In some aspects, the second RS burst may comprise CSI-RS, DMRS, SSB, PTRS, and/or any other suitable type of RS.

At action 518, the UE 115 selects a beam direction for one or more communications with the network unit 105a. In some aspects, the UE 115 may select the predicted beam identified or predicted at action 510. For example, in some aspects, responsive to the UE identifying a first beam direction of the plurality of beam directions using the beam prediction configuration, the first beam direction associated with a first error statistic of the error statistics, the UE 115 may transmit a UL communication to the network in the first beam direction. In another aspect, responsive to the UE identifying a second beam direction of the plurality of beam directions using the beam prediction model, the second beam direction associated with a second error statistic of the error statistics, the UE 115 may transmit a UL communication to the network in a third beam direction different from the second beam direction. In some aspects, the UE 115 may select the first beam direction predicted by the beam prediction model if the first error statistic associated with the first beam direction is lower than a error threshold. In another aspect, the UE 115 may select the third beam direction different from the predicted second beam direction of the second error statistic associated with the second beam direction exceeds an error threshold. It will be understood that the condition for selecting the predicted beam direction may be based on any suitable comparison with an error threshold. For example, the error threshold may represent a maximum acceptable average error rate, a minimum acceptable successful prediction rate, and/or any other suitable type of error threshold. In this regard, an error statistic for a predicted beam direction may satisfy an error threshold by exceeding an error threshold in some examples, or by being below an error threshold in other examples.

In some aspects, the UE 115 may select the beam direction based on the second RS burst transmitted at action 516. For example, based on the error statistic for the predicted beam direction failing to satisfy the error threshold, the UE 115 may obtain channel measurements of the second RS burst for each of the plurality of beam directions, and select the beam direction based on the channel measurements. As similarly explained above, the measurements may include RSRP, RSRQ, RSSI, SNR, and/or any other suitable type of measurement.

At action 520, the UE 115 transmits, to the network unit 105a based on the selected beam from action 518, a UL communication. In some aspects, transmitting the UL communication in the selected beam direction may comprise transmitting the UL communication based on a spatial filter associated with the selected beam direction. In some aspects, the UE 115 may transmit the UL communication based on a TCI state, antenna port configuration, RS ID, and/or any other suitable beam-related parameters associated with the selected beam direction.

According to some aspects of the present disclosure, the error statistics may be indicated for each beam direction. In another aspect, error statistics may be indicated for each of one or more additional parameters or variables in addition to or instead of beam direction. For example, the error statistics may include a multi-dimensional table or matrix where one dimension is beam direction, and a second dimension is power saving mode, UE location, use case, sub-use case, and/or any other suitable parameter. Thus, error statistics may be indicated per-beam, per-power saving mode, per-UE location, per-use case, per-sub-use case, and/or any other suitable data organization. Accordingly, when evaluating a ML-predicted beam based on the error statistics, the UE 115 may contemplate not only the error statistics for each beam, but also or alternatively the error statistics for each use case, each power saving mode, each UE location, and/or the error statistics associated with any other suitable parameter.

In another aspect, the UE 115 may signal to the network whether the predicted beam direction is selected by the UE 115 and will be used for communications. For example, the UE 115 may indicate to the network when the predicted beam direction will be ignored based on the associated error statistics. In some aspects, the UE 115 may transmit the indication to the network unit 105a at action 514. For example, action 514 may include the UE 115 transmitting UCI and/or a MAC-CE indicating that the predicted beam direction was not selected. The network may be configured to cause the network unit 105a to transmit the second RS burst based on the indication from the UE 115.

In another aspect, the UE 115 may be configured to assist the network to determine error statistics for each beam. For example, the UE 115 may continue to periodically receive RSs and perform channel measurements (e.g., RSRP, RSRQ, RSSI, SNR, etc.). The UE 115 may also perform a beam prediction function or algorithm to identify or predict beam performance, and may compare the predicted beam performance metrics (e.g., RSRP, RSRQ, RSSI, SNR, etc.,) with the observed channel measurements to determine an error for each beam direction. The UE 115 may transmit an error report to the network unit 105a indicating the differences between the predicted beam performance and the observed beam performance. In some aspects, the network may update the error statistics based on the UE's error report.

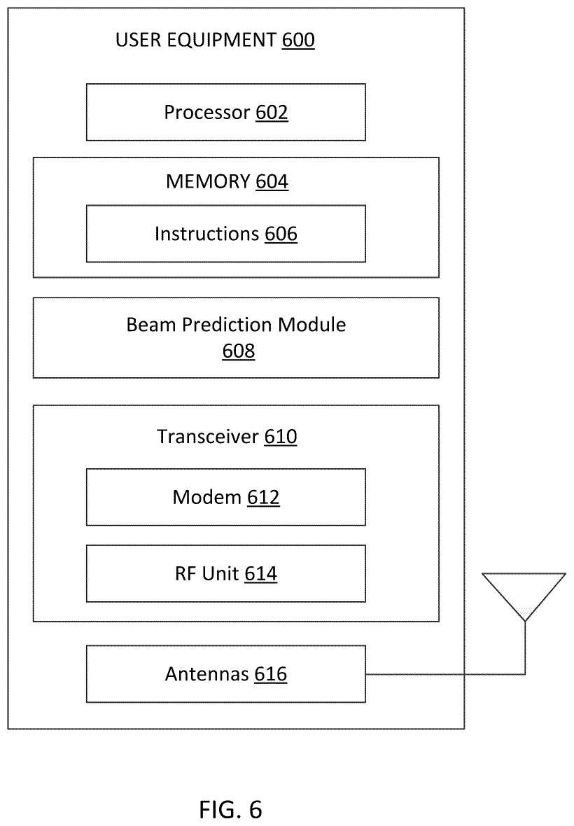

FIG. 6 is a block diagram of an exemplary UE 600 according to some aspects of the present disclosure. The UE 600 may be the UE 115 or the UE 120 in the network 100 or 200, as discussed above. As shown, the UE 600 may include a processor 602, a memory 604, a beam prediction module 608, a transceiver 610 including a modem subsystem 612 and a radio frequency (RF) unit 614, and one or more antennas 616. These elements may be coupled with each other and in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 604 includes a non-transitory computer-readable medium. The memory 604 may store instructions 606. The instructions 606 may include instructions that, when executed by the processor 602, cause the processor 602 to perform the operations described herein with reference to the UEs 115 in connection with aspects of the present disclosure, for example, aspects of FIGS. 2-5 and 8-9. Instructions 606 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The beam prediction module 608 may be implemented via hardware, software, or combinations thereof. For example, the beam prediction module 608 may be implemented as a processor, circuit, and/or instructions 606 stored in the memory 604 and executed by the processor 602. In some aspects, the beam prediction module 608 may be used to perform a beam prediction procedure based on a beam prediction configuration received from the network. The beam prediction module 608 may be further configured compare a predicted beam direction to one or more error statistics associated with the predicted beam direction, and select a beam direction based on the comparison. For example, if the error statistics for the predicted beam direction fail to satisfy a threshold, the beam prediction module 608 may be configured to select a different beam direction. For example, the beam prediction module 608 may be configured to cause the transceiver 610 to transmit an indication to the network to transmit a RS burst.

As shown, the transceiver 610 may include the modem subsystem 612 and the RF unit 614. The transceiver 610 can be configured to communicate bi-directionally with other devices, such as the BSs 105 and/or the UEs 115. The modem subsystem 612 may be configured to modulate and/or encode the data from the memory 604 and the according to a modulation and coding scheme (MCS), e.g., a low-density parity check (LDPC) coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data from the modem subsystem 612 (on outbound transmissions) or of transmissions originating from another source such as a UE 115 or a BS 105. The RF unit 614 may be further configured to perform analog beamforming in conjunction with the digital beamforming. Although shown as integrated together in transceiver 610, the modem subsystem 612 and the RF unit 614 may be separate devices that are coupled together to enable the UE 600 to communicate with other devices.

The RF unit 614 may provide the modulated and/or processed data, e.g. data packets (or, more generally, data messages that may contain one or more data packets and other information), to the antennas 616 for transmission to one or more other devices. The antennas 616 may further receive data messages transmitted from other devices. The antennas 616 may provide the received data messages for processing and/or demodulation at the transceiver 610. The antennas 616 may include multiple antennas of similar or different designs in order to sustain multiple transmission links. The RF unit 614 may configure the antennas 616.

In some instances, the UE 600 can include multiple transceivers 610 implementing different RATs (e.g., NR and LTE). In some instances, the UE 600 can include a single transceiver 610 implementing multiple RATs (e.g., NR and LTE). In some instances, the transceiver 610 can include various components, where different combinations of components can implement RATs.

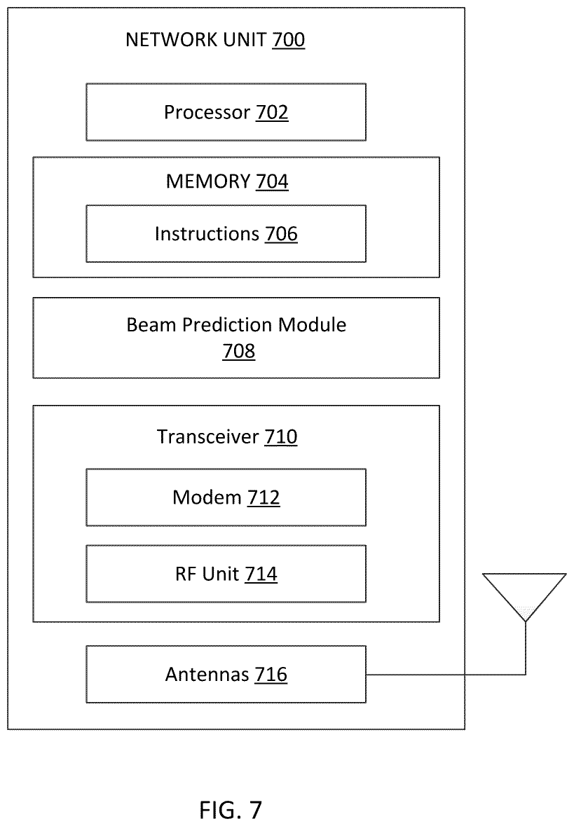

FIG. 7 is a block diagram of an exemplary network unit 700 according to some aspects of the present disclosure. The network unit 700 may be a BS 105, the CU 1210, the DU 1230, or the RU 1240, as discussed above. As shown, the network unit 700 may include a processor 702, a memory 704, a beam prediction module 708, a transceiver 710 including a modem subsystem 712 and a RF unit 714, and one or more antennas 716. These elements may be coupled with each other and in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 704 may include a non-transitory computer-readable medium. The memory 704 may store instructions 706. The instructions 706 may include instructions that, when executed by the processor 702, cause the processor 702 to perform operations described herein, for example, aspects of FIGS. 2-5 and 8-9. Instructions 706 may also be referred to as code, which may be interpreted broadly to include any type of computer-readable statement(s).

The beam prediction module 708 may be implemented via hardware, software, or combinations thereof. For example, the beam prediction module 708 may be implemented as a processor, circuit, and/or instructions 706 stored in the memory 704 and executed by the processor 702.

In some aspects, the beam prediction module 708 may implement the aspects of FIGS. 2-5 and 8-9. For example, the beam prediction module 708 may transmit, to a UE (e.g., UE 115, UE 120, or UE 600), a configuration for a beam prediction model, transmit a plurality of references signals, and receive an indication that the UE will not use a predicted beam direction.

Additionally or alternatively, the beam prediction module 708 can be implemented in any combination of hardware and software, and may, in some implementations, involve, for example, processor 702, memory 704, instructions 706, transceiver 710, and/or modem 712.

As shown, the transceiver 710 may include the modem subsystem 712 and the RF unit 714. The transceiver 710 can be configured to communicate bi-directionally with other devices, such as the UEs 115 and/or 600. The modem subsystem 712 may be configured to modulate and/or encode data according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or UE 600. The RF unit 714 may be further configured to perform analog beamforming in conjunction with the digital beamforming. Although shown as integrated together in transceiver 710, the modem subsystem 712 and/or the RF unit 714 may be separate devices that are coupled together at the network unit 700 to enable the network unit 700 to communicate with other devices.

The RF unit 714 may provide the modulated and/or processed data, e.g. data packets (or, more generally, data messages that may contain one or more data packets and other information), to the antennas 716 for transmission to one or more other devices. This may include, for example, a configuration indicating a plurality of sub-slots within a slot according to aspects of the present disclosure. The antennas 716 may further receive data messages transmitted from other devices and provide the received data messages for processing and/or demodulation at the transceiver 710. The antennas 716 may include multiple antennas of similar or different designs in order to sustain multiple transmission links.

In some instances, the network unit 700 can include multiple transceivers 710 implementing different RATs (e.g., NR and LTE). In some instances, the network unit 700 can include a single transceiver 710 implementing multiple RATs (e.g., NR and LTE). In some instances, the transceiver 710 can include various components, where different combinations of components can implement RATs.

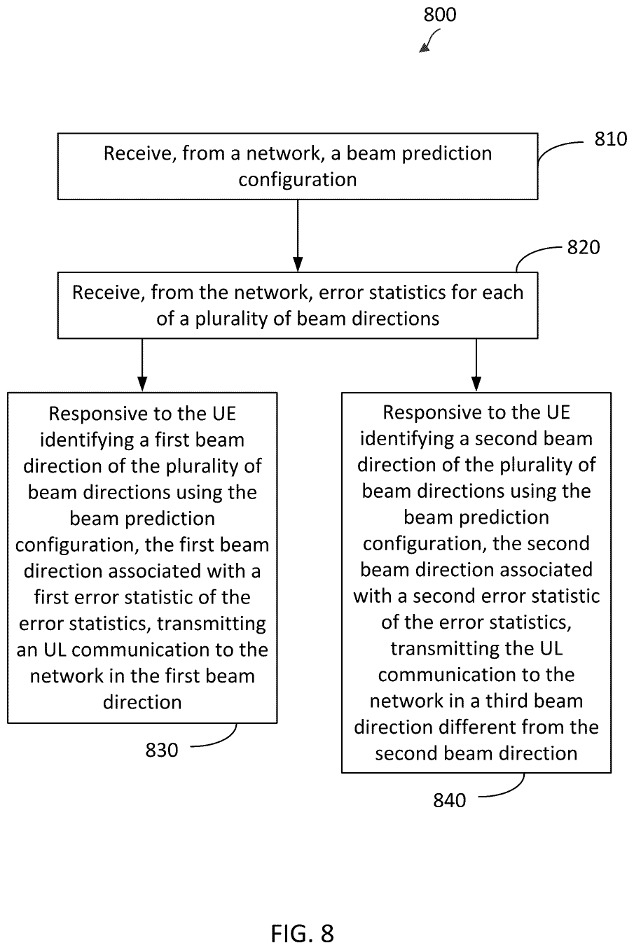

FIG. 8 is a flow diagram of a communication method 800 according to some aspects of the present disclosure. Aspects of the method 800 can be executed by a computing device (e.g., a processor, processing circuit, and/or other suitable component) of a wireless communication device or other suitable means for performing the aspects. For example, a wireless communication device, such as the UE 115, UE 120, or UE 600 may utilize one or more components to execute aspects of method 800. The method 800 may employ similar mechanisms as in the networks 100 and 200 and the aspects and actions described with respect to FIGS. 2-5. For example, a wireless communication device, such as the UE 115 or 600, may utilize one or more components, such as such as the processor 602, the memory 604, the beam prediction module 608, the transceiver 610, the modem 612, and the one or more antennas 616, to execute aspects of the method 800. As illustrated, the method 800 includes a number of enumerated aspects, but the method 800 may include additional aspects before, after, and in between the enumerated aspects. In some aspects, one or more of the enumerated aspects may be omitted or performed in a different order.

At action 810, the UE receives, from a network, a beam prediction configuration. In some aspects, receiving the beam prediction configuration may comprise receiving a configuration for a machine learning (ML) module. The UE may receive the machine learning configuration from a network unit via RRC signaling, a PDCCH communication, a PDSCH communication, or other suitable communication. The beam prediction configuration may include, without limitation, identification of ML model inputs, weights, vectors, coefficients, equations, algorithms, type of ML model, etc. The beam prediction configuration may be used by the UE to perform a ML algorithm to predict beam characteristics of each of a plurality of beam directions. In some aspects, the ML algorithm may be used by the UE to predict a best beam direction, one or more acceptable beam directions, and/or to rank beam directions based on their predicted performance for a given time, location, use-case, and/or power saving mode of the UE. The UE may perform a beam prediction procedure using the beam prediction configuration and one or more associated inputs and/or input parameters. The inputs may include signal or channel measurements, such as signal power, signal quality, signal-to-noise ratio (SNR), and/or any other suitable type of channel measurements. In some aspects, the inputs may include measurements suitable for reporting in a channel state information (CSI) report. Further, the input parameters may include a time associated with the measurements (e.g., a timestamp, time window, etc.), a power-saving mode status of the UE, a current and/or future use-case for the UE's communications, and/or any other suitable parameter.

For example, the beam prediction configuration may indicate one or more parameters for a neural network function (NNF). The NNF may be supported by a beam prediction model. The beam prediction model may be a neural network model. The neural network model may include, or be associated with, a model structure. The neural network model may be defined as a model structure and a parameter set. The neural network model may be hard coded in the UE. The model structure may be indicated with a model ID. The model ID may be associated with one parameter set. For example, a first model ID may be associated with a first model structure and a first parameter set, and a second model ID may be associated with a second model structure and a second parameter set. The first model structure may be different from the second model structure. The first parameter may be different from the second parameter set. In some aspects, each model ID may be unique in the corresponding network. In another aspect, each model ID may be associated with or correspond to a NNF. A parameter set may include, for example, weights for the neural network model and/or other ML configuration parameters. The parameter set may be specific to a location, on some aspects. The NNF may be executable by the UE and may receive, as inputs, one or more channel measurements obtained and/or stored by the UE, and/or one or more other parameters. The one or more other parameters may include a current time, UE use case and/or sub-use case, power saving mode status, and/or any other suitable input.

At action 820, the UE receives, from the network, error statistics for each of a plurality of beam directions. In some aspects, the UE may receive the error statistics with the beam prediction configuration. In other aspects, the UE may receive the error statistics separately from the beam prediction configuration. In some aspects, a network unit may transmit the error statistics via a RRC IE, a MAC-IE, MAC-CE, DCI, and/or any other suitable communication or message. In some aspects, the error statistics may be generated based on a ML training procedure performed by the network. For example, training losses and/or losses during validation of a dataset may be obtained to generate an error data-set indicating one or more error statistics for each of the plurality of beam directions. In some aspects, the statistics may include an error rate for each beam direction. In some aspects, the error statistics may include an average error rate for each beam direction. In other aspects, the statistics may indicate a relative ranking or likelihood of error for each beam direction. In another aspect, the statistics may indicate one or more beam directions associated with a highest rate of error. In another aspect, the error statistics may indicate, for each of the plurality of beam directions, a difference in signal power between the respective predicted beam direction and an observed best beam direction. In another aspect, the error statistics may indicate, for each of the plurality of beam directions, a different in signal strength, signal quality, SNR, and/or any other suitable beam direction between the respective predicted beam direction and the observed best beam direction.

In one aspect, the beam error statistics may be relative to the “predicted” best beam direction, or a “genie” best beam direction. In some aspects, the predicted best beam direction may be the beam that is predicted by the ML-based beam prediction configuration. The “genie” best beam direction may be described as an actual observed best beam direction that is determined based on contemporaneous RS measurements. For example, a first type of error statistics may be determined and provided by the network based on genie beam association. In a different example, a second type of error statistics may be determined and provided based on a predicted beam association.

At step 830, responsive to the UE identifying a first beam direction of the plurality of beam directions using the beam prediction configuration, the first beam direction associated with a first error statistic of the error statistics, transmitting a UL communication to the network in the first beam direction. In some aspects, transmitting the UL communication comprises transmitting a PUCCH communication, a PUSCH communication, a UL RS, and/or any other suitable type of communication. In an alternative aspect, step 830 may comprise receiving a DL communication based on the first beam direction. In some aspects, the DL communication may be a PDCCH communication, a PDSCH communication, a RRC message, a DL RS, and/or any other suitable type of communication.

At step 840, responsive to the UE identifying a second beam direction of the plurality of beam directions using the beam prediction configuration, the second beam direction associated with a second error statistic of the error statistics different from the first error statistic, transmitting the UL communication to the network in a third beam direction different from the second beam direction. In some aspects, transmitting the UL communication comprises transmitting a PUCCH communication, a PUSCH communication, a UL RS, and/or any other suitable type of communication. In an alternative aspect, step 840 may comprise receiving a DL communication based on the third beam direction. In some aspects, the DL communication may be a PDCCH communication, a PDSCH communication, a RRC message, a DL RS, and/or any other suitable type of communication.

It will be understood that steps 830 and 840 may be alternative steps performed based on the conditions to which they are responsive. Performing the steps of 830 and/or 840 may include the UE executing or performing a beam prediction procedure based on the NNF, which may output a beam prediction. In some aspects, the beam prediction may include a best predicted beam direction of the plurality of beam directions. In another aspect, the beam prediction may include a ranking of two or more beam directions of the plurality of beam directions. In another aspect, the beam prediction may include one or more beam directions that exceed a predicted threshold of channel performance, such as predicted RSRP, RSRQ, SNR, and/or any other suitable performance threshold. In another aspect, the beam prediction may include a predicted performance for each beam direction of the plurality of beam directions. Accordingly, the UE may identify, based on the beam prediction, a best predicted beam direction.

In some aspects, steps 830 and/or 840 comprise comparing the error statistics associated with each predicted beam direction with an associated error threshold. In this regard, the first beam direction may be associated with a first error threshold, and the second beam direction may be associated with a second error threshold. The UE may proceed to select the predicted beam if the associated error statistics satisfy the respective error threshold for the predicted beam. For example, the error threshold may indicate a maximum acceptable error rate (e.g., average error rate, mean error rate, etc.) for the beam direction, a maximum acceptable difference in signal power between the respective beam direction and an observed best beam direction, a minimum acceptable confidence ranking, and/or any other suitable type of error threshold.

In some aspects, the method 800 may include a network unit transmitting, and the UE receiving, an indication of one or more error thresholds associated with one or more beam directions. For example, the method 800 may include the UE receiving, from the network unit, a RRC message, a MAC-CE, and/or any other suitable message indicating the error thresholds. In another aspect, the error thresholds may be statically configured at the UE. In another aspect, the error thresholds may be based on UE implementation whereby the UE may modify or update the error thresholds autonomously. In some aspects, an error threshold may be provided for each beam direction of the plurality of beam directions. In another example, a single threshold may be provided for the plurality of beam directions. In another aspect, an error threshold may indicate a lowest acceptable ranking for beam prediction error. For example, the threshold may indicate that the n^{th} least erroneous beam directions are acceptable for prediction by the ML model, and that any beam directions that the n−1 beam directions that have higher relative likelihoods of erroneous beam prediction are unacceptable for prediction by the ML model.

In some aspects, comparing the error statistics for the predicted beam direction with the configured error threshold may result in the UE determining or selecting the beam direction determined or predicted based on the beam prediction configuration communicate with the network, as in step 830. In another example, comparing the error statistics for the predicted beam direction with the configured error threshold may result in the UE determining or selecting a different beam direction that is not the predicted beam direction to communicate with the network, as in step 840. Accordingly, the error statistics and configured threshold may facilitate a conditional application of the beam prediction model to prevent the UE from using a predicted beam that is more likely to be erroneously predicted by the beam prediction model.

Accordingly, the UE may select the first beam direction predicted based on the beam prediction configuration if the first error statistic associated with the first beam direction is lower than an error threshold. In another aspect, the UE may select the third beam direction different from the predicted second beam direction of the second error statistic associated with the second beam direction exceeds an error threshold. It will be understood that the condition for selecting the predicted beam direction may be based on any suitable comparison with an error threshold. For example, the error threshold may represent a maximum acceptable average error rate, a minimum acceptable successful prediction rate, and/or any other suitable type of error threshold. In this regard, an error statistic for a predicted beam direction may satisfy an error threshold by exceeding an error threshold in some examples, or by being below an error threshold in other examples. For example, the UE may transmit the UL communication in the first beam direction responsive to a first error statistic associated with the first beam direction exceeding a first threshold. As explained above, the first threshold may be an average error rate threshold, an average success rate threshold, a beam prediction accuracy ranking, or any other suitable threshold. In another aspect, the UE may transmit the UL communication in the third beam direction responsive to a second error statistic associated with the second beam direction being below a second threshold. The second threshold may be an average error rate threshold, an average success rate threshold, a beam prediction accuracy ranking, or any other suitable threshold. In some aspects, the first and second thresholds may be referred to as error thresholds.

In some aspects, the error thresholds may be based on the error statistics for each beam direction. For example, the error threshold may indicate a difference between a beam prediction probability determined using the beam prediction configuration and an error probability of the beam direction as indicated in the error statistics. Accordingly, if the beam prediction probability determined based on the beam prediction model or neural network model is higher than the error probability by at least the indicated error threshold, the UE may select the predicted beam direction (e.g., first beam direction) for UL communications. Otherwise, the UE may select a different beam direction (e.g., third beam direction). In one example, the transmitting the UL communication in the first beam direction is based on a first beam prediction probability of the first beam direction exceeding a first beam prediction threshold, where the first beam prediction probability is based on the beam prediction configuration. In another example, the transmitting the UL communication in the third beam direction is based on a second beam prediction probability of the second beam direction being smaller than a second beam prediction threshold, where the second beam prediction probability is based on the beam prediction configuration.

In some aspects, the method 800 further includes the UE transmitting, to the network, an indication that the UE will not use the predicted beam direction. For example, based on the scenario of step 840, the UE may transmit, to the network, an indication that the UE will not use the second beam direction for UL and/or DL communications. In one aspect, the method 800 may include the UE transmitting, to the network, a request for an RS burst. In some aspects, the UE may request an aperiodic RS burst, or instance of a RS burst. In another aspect, the UE may request the network to activate a semi-persistent RS or RS burst. In another aspect, the UE may not request the network to activate the semi-persistent RS. For example, the UE may revert to a previously active or configured beam direction, and may wait for the next periodically or semi-periodically configured RS burst. In this regard, step 840 may include the UE continuing to communicate using the previously indicated or selected beam direction before identifying the predicted beam direction. In some aspects, transmitting the request for the RS burst to the network may comprise transmitting a UCI, a MAC-CE, and/or any other suitable message.

In another aspect, the method 800 may further include the UE receiving, based on the request, a RS burst. The RS burst may comprise instances of a RS in each of the plurality of beam directions. In some aspects, the RS burst may comprise CSI-RS, DMRS, SSB, PTRS, and/or any other suitable type of RS. The UE may perform channel measurements (e.g., RSRP, RSRQ, RSSI, SNR, etc.) based on the RS burst. The UE may select the third beam direction based on the channel measurements.

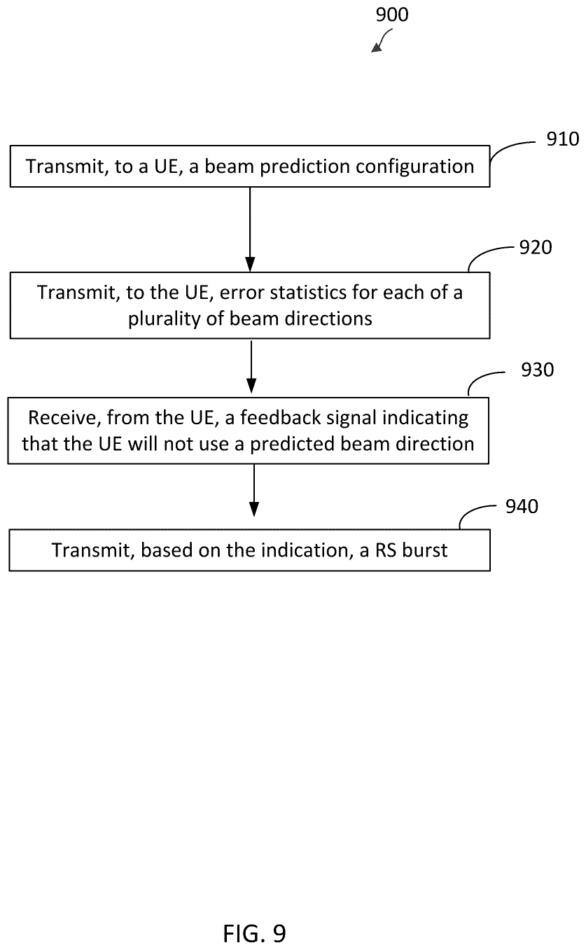

FIG. 9 is a flow diagram of a communication method 900 according to some aspects of the present disclosure. Aspects of the method 900 can be executed by a computing device (e.g., a processor, processing circuit, and/or other suitable component) of a wireless communication device or other suitable means for performing the aspects. For example, a wireless communication device, such as the network unit 105a or 700 may utilize one or more components to execute aspects of method 900. The method 900 may employ similar mechanisms as in the networks 100 and 200 and the aspects and actions described with respect to FIGS. 2-5. For example, a wireless communication device, such as the network unit 105a or 700, may utilize one or more components, such as such as the processor 702, the memory 704, the beam prediction module 708, the transceiver 710, the modem 712, and the one or more antennas 716, to execute aspects of the method 900. As illustrated, the method 900 includes a number of enumerated aspects, but the method 900 may include additional aspects before, after, and in between the enumerated aspects. In some aspects, one or more of the enumerated aspects may be omitted or performed in a different order.

At action 910, the network unit transmits, to a UE, a beam prediction configuration. In some aspects, receiving the beam prediction configuration may comprise receiving a configuration for a machine learning (ML) module. The network unit may transmit the beam prediction configuration via RRC signaling, a PDCCH communication, a PDSCH communication, or other suitable communication. The beam prediction configuration may include, without limitation, identification of ML model inputs, weights, vectors, coefficients, equations, algorithms, type of ML model, etc. The beam prediction configuration may be used by the UE to perform a ML algorithm to predict beam characteristics of each of a plurality of beam directions. In some aspects, the ML algorithm may be used by the UE to predict a best beam direction, one or more acceptable beam directions, and/or to rank beam directions based on their predicted performance for a given time, location, use-case, and/or power saving mode of the UE. The inputs to the ML model may include signal or channel measurements, such as signal power, signal quality, SNR, and/or any other suitable type of channel measurements. In some aspects, the inputs may include measurements suitable for reporting in a CSI report. Further, the input parameters may include a time associated with the measurements (e.g., a timestamp, time window, etc.), a power-saving mode status of the UE, a current and/or future use-case for the UE's communications, and/or any other suitable parameter.

For example, the beam prediction configuration may indicate one or more parameters for a neural network function (NNF). The NNF may be supported by a beam prediction model. The beam prediction model may be a neural network model. The neural network model may include, or be associated with, a model structure. The neural network model may be defined as a model structure and a parameter set. The neural network model may be hard coded in the UE. The model structure may be indicated with a model ID. For example, the beam prediction configuration may indicate a model ID. The model ID may be associated with one parameter set. For example, a first model ID may be associated with a first model structure and a first parameter set, and a second model ID may be associated with a second model structure and a second parameter set. The first model structure may be different from the second model structure. The first parameter may be different from the second parameter set. In some aspects, each model ID may be unique in the corresponding network. In another aspect, each model ID may be associated with or correspond to a NNF. A parameter set may include, for example, weights for the neural network model and/or other ML configuration parameters. The parameter set may be specific to a location, on some aspects. The NNF may be executable by the UE and may receive, as inputs, one or more channel measurements obtained and/or stored by the UE, and/or one or more other parameters. The one or more other parameters may include a current time, UE use case and/or sub-use case, power saving mode status, and/or any other suitable input.

At action 920, the network unit transmits, to the UE, error statistics for each of a plurality of beam directions. In some aspects, the network unit may transmit the error statistics with the beam prediction configuration. In other aspects, the network unit may transmit the error statistics separately from the beam prediction configuration. In some aspects, the network unit may transmit the error statistics via a RRC IE, a MAC-IE, MAC-CE, DCI, and/or any other suitable communication or message. In some aspects, the error statistics may be generated by the network unit based on a ML training procedure performed by the network. For example, training losses and/or losses during validation of a dataset may be obtained to generate an error data-set indicating one or more error statistics for each of the plurality of beam directions. In some aspects, the statistics may include an error rate for each beam direction. In some aspects, the error statistics may include an average error rate for each beam direction. In other aspects, the statistics may indicate a relative ranking or likelihood of error for each beam direction. In another aspect, the statistics may indicate one or more beam directions associated with a highest rate of error. In another aspect, the error statistics may indicate, for each of the plurality of beam directions, a difference in signal power between the respective predicted beam direction and an observed best beam direction. In another aspect, the error statistics may indicate, for each of the plurality of beam directions, a different in signal strength, signal quality, SNR, and/or any other suitable beam direction between the respective predicted beam direction and the observed best beam direction.

In one aspect, the beam error statistics may be relative to the “predicted” best beam direction, or a “genie” best beam direction. In some aspects, the predicted best beam direction may be the beam that is predicted by the ML-based beam prediction configuration. The “genie” best beam direction may be described as an actual observed best beam direction that is determined based on contemporaneous RS measurements. For example, a first type of error statistics may be determined and provided by the network based on genie beam association. In a different example, a second type of error statistics may be determined and provided based on a predicted beam association.

At step 930, the network unit receives, from the UE, an indication that the UE will not use a predicted beam direction determined based on the beam prediction configuration. In one aspect, step 930 may include the network unit receiving, from the UE, a request for an RS burst. In some aspects, the UE may request an aperiodic RS burst, or instance of a RS burst. In another aspect, the UE may request the network to activate a semi-persistent RS or RS burst. In some aspects, receiving the request for the RS burst may comprise receiving a UCI, a MAC-CE, and/or any other suitable message.

At step 940, the network unit transmits, based on the indication, a RS burst. The RS burst may comprise instances of a RS in each of the plurality of beam directions. In some aspects, the RS burst may comprise CSI-RS, DMRS, SSB, PTRS, and/or any other suitable type of RS. The UE may perform channel measurements (e.g., RSRP, RSRQ, RSSI, SNR, etc.) based on the RS burst. The UE may select the third beam direction based on the channel measurements.

In some aspects, the method 900 may include a network unit transmitting, and the UE receiving, an indication of one or more error thresholds associated with one or more beam directions. For example, the method 900 may include the network unit transmitting a RRC message, a MAC-CE, and/or any other suitable message indicating the error thresholds. In some aspects, an error threshold may be provided for each beam direction of the plurality of beam directions. In another example, a single threshold may be provided for the plurality of beam directions. In another aspect, an error threshold may indicate a lowest acceptable ranking for beam prediction error. For example, the threshold may indicate that the n^{th} least erroneous beam directions are acceptable for prediction by the ML model, and that any beam directions that the n−1 beam directions that have higher relative likelihoods of erroneous beam prediction are unacceptable for prediction by the ML model.

In some aspects, the error thresholds may be based on the error statistics for each beam direction. For example, the error threshold may indicate a difference between a beam prediction probability determined using the beam prediction configuration and an error probability of the beam direction as indicated in the error statistics. Accordingly, if the beam prediction probability determined based on the beam prediction model or neural network model is higher than the error probability by at least the indicated error threshold, the UE may select the predicted beam direction (e.g., first beam direction) for UL communications. Otherwise, the UE may select a different beam direction (e.g., third beam direction).

Further aspects of the present disclosure include the following:
Aspect 1. A method of wireless communication performed by a user equipment (UE), the method comprising: receiving, from a network, a beam prediction configuration; receiving, from the network, error statistics for each of a plurality of beam directions; responsive to the UE identifying a first beam direction of the plurality of beam directions using the beam prediction configuration, the first beam direction associated with a first error statistic of the error statistics, transmitting an uplink (UL) communication to the network in the first beam direction; and responsive to the UE identifying a second beam direction of the plurality of beam directions using the beam prediction configuration, the second beam direction associated with a second error statistic of the error statistics different from the first error statistic, transmitting the UL communication to the network in a third beam direction different from the second beam direction.
Aspect 2. The method of aspect 1, wherein the beam prediction configuration comprises a machine learning configuration.
Aspect 3. The method of aspect 2, further comprising: identifying the first beam direction based on the machine learning configuration and channel measurements associated with the plurality of beam directions; or identifying the second beam direction based on the machine learning configuration and channel measurements associated with the plurality of beam directions.
Aspect 4. The method of any of aspects 1-3, wherein the error statistics indicate, for each of the plurality of beam directions, at least one of: an error rate; or a difference in a signal power between the respective beam direction and a best beam direction.
Aspect 5. The method any of aspects 1-4, wherein: the transmitting the UL communication in the first beam direction comprises: responsive to the first error statistic exceeding a first threshold associated with the first beam direction, selecting the first beam direction for the transmitting the UL communication; and the transmitting the UL communication in the third beam direction comprises: responsive to the second error statistic being below a second threshold associated with the second beam direction, selecting the third beam direction for the transmitting the UL communication.
Aspect 6. The method of any of aspects 1-5, further comprising: transmitting, to the network, a feedback signal indicating the second error statistic is below a threshold, obtaining channel measurements of a reference signal burst in the plurality of beam directions; and selecting, based on the channel measurements, the third beam direction for the UL communication.
Aspect 7. The method of any of aspects 1-6, further comprising: receiving, from the network, at least one signal indicating a first error threshold for the first beam direction and a second error threshold for the second beam direction, wherein the transmitting the UL communication in the first beam direction is based on a comparison of the first error statistic with the first error threshold, and wherein the transmitting the UL communication in the third beam direction is based on a comparison of the second error statistic with the second error threshold.
Aspect 8. The method of any of aspects 1-7, wherein: the transmitting the UL communication in the first beam direction is based on a first beam prediction probability of the first beam direction exceeding a first beam prediction threshold, wherein the first beam prediction probability is based on the beam prediction configuration; and the transmitting the UL communication in the third beam direction is based on a second beam prediction probability of the second beam direction being smaller than a second beam prediction threshold, wherein the second beam prediction probability is based on the beam prediction configuration.
Aspect 9. The method of aspect 8, wherein: the first beam prediction threshold is based on the first error statistic; and the second beam prediction threshold is based on the second error statistic.
Aspect 10. The method of any of aspects 1-9, wherein the error statistics for each beam direction of the plurality of beam directions comprise: error statistics for the beam direction; and error statistics for at least one additional parameter, the at least one additional parameter comprising one or more of: a power saving mode of the UE; a location of the UE; or a sub-use case of the UE.
Aspect 11. A method of wireless communication performed by a network unit, the method comprising: transmitting, to a user equipment (UE), a beam prediction configuration; transmitting, to the UE, error statistics for each of a plurality of beam directions; receiving, from the UE, a feedback signal indicating an error statistic for a predicted beam direction is below a threshold; and transmitting, to the UE based on the feedback signal, one or more reference signals in each of the plurality of beam directions.
Aspect 12. The method of aspect 11, wherein the beam prediction configuration comprises a machine learning configuration.
Aspect 13. The method of any of aspects 11-12, wherein the error statistics indicate, for each of the plurality of beam directions, at least one of: an error rate; or a difference in a signal power between the respective beam direction and a best beam direction.
Aspect 14. The method of any of aspects 11-13, further comprising: transmitting, to the UE, at least one signal indicating a first error threshold for a first beam direction and a second error threshold for a second beam direction, wherein: the first error threshold is based on a first error statistic associated with the first beam direction, the first error statistic indicated in the error statistics; and the second error threshold is based on a second error statistic associated with the second beam direction, the second error statistic indicated in the error statistics.
Aspect 15. The method of any of aspects 11-14, wherein the error statistics for each beam direction of the plurality of beam directions comprise: error statistics for the beam direction; and error statistics for at least one additional parameter, the at least one additional parameter comprising one or more of: a power saving mode of the UE; a location of the UE; or a sub-use case of the UE.
Aspect 16. A UE, comprising: a memory device, a transceiver, and a processor in communication with the memory device and the transceiver, wherein the UE is configured to perform the steps of any of aspects 1-10.
Aspect 17. A network unit, comprising: a memory device, a transceiver, and a processor in communication with the memory device and the transceiver, wherein the network unit is configured to perform the steps of any of aspects 11-15.
Aspect 18. A non-transitory, computer-readable medium having program code recorded thereon, wherein the program code comprises instructions executable by a processor of a UE to cause the UE to perform the steps of any of aspects 1-10.
Aspect 19. A non-transitory, computer-readable medium having program code recorded thereon, wherein the program code comprises instructions executable by a processor of a network unit to cause the network unit to perform the steps of any of aspects 11-15.
Aspect 20. A UE comprising means for performing the steps of any of aspects 1-10.
Aspect 21. A network unit comprising means for performing the steps of any of aspects 11-15.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

What is claimed is:

1. A method of wireless communication performed by a user equipment (UE), the method comprising:
receiving, from a network, a beam prediction configuration;
receiving, from the network, error statistics for each of a plurality of beam directions;
responsive to the UE identifying a first beam direction of the plurality of beam directions using the beam prediction configuration, the first beam direction associated with a first error statistic of the error statistics, transmitting an uplink (UL) communication to the network in the first beam direction; and
responsive to the UE identifying a second beam direction of the plurality of beam directions using the beam prediction configuration, the second beam direction associated with a second error statistic of the error statistics different from the first error statistic, transmitting the UL communication to the network in a third beam direction different from the second beam direction.

2. The method of claim 1, wherein the beam prediction configuration comprises a machine learning configuration.

3. The method of claim 2, further comprising:
identifying the first beam direction based on the machine learning configuration and channel measurements associated with the plurality of beam directions; or
identifying the second beam direction based on the machine learning configuration and channel measurements associated with the plurality of beam directions.

4. The method of claim 1, wherein the error statistics indicate, for each of the plurality of beam directions, at least one of:
an error rate; or
a difference in a signal power between the respective beam direction and a best beam direction.

5. The method of claim 1, wherein:
the transmitting the UL communication in the first beam direction comprises:
responsive to the first error statistic exceeding a first threshold associated with the first beam direction, selecting the first beam direction for the transmitting the UL communication; and
the transmitting the UL communication in the third beam direction comprises:
responsive to the second error statistic being below a second threshold associated with the second beam direction, selecting the third beam direction for the transmitting the UL communication.

6. The method of claim 1, further comprising:
transmitting, to the network, a feedback signal indicating the second error statistic is below a threshold,
obtaining channel measurements of a reference signal burst in the plurality of beam directions; and
selecting, based on the channel measurements, the third beam direction for the UL communication.

7. The method of claim 1, further comprising:
receiving, from the network, at least one signal indicating a first error threshold for the first beam direction and a second error threshold for the second beam direction,
wherein the transmitting the UL communication in the first beam direction is based on a comparison of the first error statistic with the first error threshold, and
wherein the transmitting the UL communication in the third beam direction is based on a comparison of the second error statistic with the second error threshold.

8. The method of claim 1, wherein:
the transmitting the UL communication in the first beam direction is based on a first beam prediction probability of the first beam direction exceeding a first beam prediction threshold, wherein the first beam prediction probability is based on the beam prediction configuration; and
the transmitting the UL communication in the third beam direction is based on a second beam prediction probability of the second beam direction being smaller than a second beam prediction threshold, wherein the second beam prediction probability is based on the beam prediction configuration.

9. The method of claim 8, wherein:
the first beam prediction threshold is based on the first error statistic; and
the second beam prediction threshold is based on the second error statistic.

10. The method of claim 1, wherein the error statistics for each beam direction of the plurality of beam directions comprise:
error statistics for the beam direction; and
error statistics for at least one additional parameter, the at least one additional parameter comprising one or more of:
a power saving mode of the UE;
a location of the UE; or
a sub-use case of the UE.

11. A method of wireless communication performed by a network unit, the method comprising:
transmitting, to a user equipment (UE), a beam prediction configuration;
transmitting, to the UE, error statistics for each of a plurality of beam directions;
receiving, from the UE, a feedback signal indicating an error statistic for a predicted beam direction is below a threshold; and
transmitting, to the UE based on the feedback signal, one or more reference signals in each of the plurality of beam directions.

12. The method of claim 11, wherein the beam prediction configuration comprises a machine learning configuration.

13. The method of claim 11, wherein the error statistics indicate, for each of the plurality of beam directions, at least one of:
an error rate; or
a difference in a signal power between the respective beam direction and a best beam direction.

14. The method of claim 11, further comprising:
transmitting, to the UE, at least one signal indicating a first error threshold for a first beam direction and a second error threshold for a second beam direction,
wherein:
the first error threshold is based on a first error statistic associated with the first beam direction, the first error statistic indicated in the error statistics; and
the second error threshold is based on a second error statistic associated with the second beam direction, the second error statistic indicated in the error statistics.

15. The method of claim 11, wherein the error statistics for each beam direction of the plurality of beam directions comprise:
error statistics for the beam direction; and
error statistics for at least one additional parameter, the at least one additional parameter comprising one or more of:
a power saving mode of the UE;
a location of the UE; or
a sub-use case of the UE.

16. A user equipment (UE), comprising:
a memory device;
a transceiver; and
a processor in communication with the memory device and the transceiver, wherein the UE is configured to:
receive, from a network, a beam prediction configuration;
receive, from the network, error statistics for each of a plurality of beam directions;
responsive to the UE identifying a first beam direction of the plurality of beam directions using the beam prediction configuration, the first beam direction associated with a first error statistic of the error statistics, transmit an uplink (UL) communication to the network in the first beam direction; and
responsive to the UE identifying a second beam direction of the plurality of beam directions using the beam prediction configuration, the second beam direction associated with a second error statistic of the error statistics different from the first error statistic, transmit the UL communication to the network in a third beam direction different from the second beam direction.

17. The UE of claim 16, wherein the beam prediction configuration comprises a machine learning configuration.

18. The UE of claim 17, wherein the UE is further configured to:
identify the first beam direction based on the machine learning configuration and channel measurements associated with the plurality of beam directions; or
identify the second beam direction based on the machine learning configuration and channel measurements associated with the plurality of beam directions.

19. The UE of claim 16, wherein the error statistics indicate, for each of the plurality of beam directions, at least one of:
an error rate; or
a difference in a signal power between the respective beam direction and a best beam direction.

20. The UE of claim 16, wherein:
the UE configured to transmit the UL communication in the first beam direction comprises the UE configured to:
responsive to the first error statistic exceeding a first threshold associated with the first beam direction, select the first beam direction for the transmitting the UL communication; and
the transmitting the UL communication in the third beam direction comprises:
responsive to the second error statistic being below a second threshold associated with the second beam direction, select the third beam direction for the transmitting the UL communication.

21. The UE of claim 16, wherein the UE is further configured to:
transmit, to the network, a feedback signal indicating the second error statistic is below a threshold,
obtain channel measurements of a reference signal burst in the plurality of beam directions; and
select, based on the channel measurements, the third beam direction for the UL communication.

22. The UE of claim 16, wherein the UE is further configured to:
receive, from the network, at least one signal indicating a first error threshold for the first beam direction and a second error threshold for the second beam direction,
wherein the transmitting the UL communication in the first beam direction is based on a comparison of the first error statistic with the first error threshold, and
wherein the transmitting the UL communication in the third beam direction is based on a comparison of the second error statistic with the second error threshold.

23. The UE of claim 16, wherein:
the UE configured to transmit the UL communication in the first beam direction is based on a first beam prediction probability of the first beam direction exceeding a first beam prediction threshold, wherein the first beam prediction probability is based on the beam prediction configuration; and
the UE configured to transmit the UL communication in the third beam direction is based on a second beam prediction probability of the second beam direction being smaller than a second beam prediction threshold, wherein the second beam prediction probability is based on the beam prediction configuration.

24. The UE of claim 23, wherein:
the first beam prediction threshold is based on the first error statistic; and
the second beam prediction threshold is based on the second error statistic.

25. The UE of claim 16, wherein the error statistics for each beam direction of the plurality of beam directions comprise:
error statistics for the beam direction; and
error statistics for at least one additional parameter, the at least one additional parameter comprising one or more of:
a power saving mode of the UE;
a location of the UE; or
a sub-use case of the UE.

26. A network unit, comprising:
a memory device;
a transceiver; and
a processor in communication with the memory device and the transceiver, wherein the network unit is configured to:
transmit, to a user equipment (UE), a beam prediction configuration;
transmit, to the UE, error statistics for each of a plurality of beam directions;
receive, from the UE, a feedback signal indicating an error statistic for a predicted beam direction is below a threshold; and
transmit, to the UE based on the feedback signal, one or more reference signals in each of the plurality of beam directions.

27. The network unit of claim 26, wherein the beam prediction configuration comprises a machine learning configuration.

28. The network unit of claim 26, wherein the error statistics indicate, for each of the plurality of beam directions, at least one of:
an error rate; or
a difference in a signal power between the respective beam direction and a best beam direction.

29. The network unit of claim 26, wherein the network unit is further configured to:
transmit, to the UE, at least one signal indicating a first error threshold for a first beam direction and a second error threshold for a second beam direction,
wherein:
the first error threshold is based on a first error statistic associated with the first beam direction, the first error statistic indicated in the error statistics; and
the second error threshold is based on a second error statistic associated with the second beam direction, the second error statistic indicated in the error statistics.

30. The network unit of claim 26, wherein the error statistics for each beam direction of the plurality of beam directions comprise:
error statistics for the beam direction; and
error statistics for at least one additional parameter, the at least one additional parameter comprising one or more of:
a power saving mode of the UE;
a location of the UE; or
a sub-use case of the UE.
